(19) United States
(12) Patent Application Publication
(10) Pub. No.: US 2023/0158504 A1
(43) Pub. Date: May 25, 2023

(54) DIGITAL MICROFLUIDIC SYSTEMS FOR MANIPULATING DROPLETS

(71) Applicant: UNIVERSITY OF PITTSBURGH-OF THE COMMONWEALTH SYSTEM OF HIGHER EDUCATION, PITTSBURGH, PA (US)

(72) Inventors: HONGYAO GENG, PITTSBURGH, PA (US); SUNG KWON CHO, PITTSBURGH, PA (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 18/159,284

(22) Filed: Jan. 25, 2023

Related U.S. Application Data
(62) Division of application No. 16/464,766, filed on May 29, 2019, now abandoned.
(60) Provisional application No. 62/431,497, filed on Dec. 8, 2016.

(51) Int. Cl. B01L 3/00; G01N 27/06; G01N 27/447

(52) U.S. Cl. CPC B01L 3/502792; G01N 27/06; G01N 27/44769; B01L 2300/161; B01L 2400/0427

(57) ABSTRACT

A digital microfluidic system includes a substrate, a plurality of electrode sets provided on the substrate, wherein each of the electrode sets includes two co-planar interdigitated finger electrodes, and a driving circuit including an AC/DC voltage source and a controller. Each of the electrode sets is individually addressable by the driving circuit under control of the controller such that an AC/DC voltage generated by the AC/DC voltage source may be selectively provided to one or more of the electrode sets. Also, an anti-biofouling electrode for a digital microfluidic system includes an electrode layer, and a slippery liquid infused porous surface structure provided on the electrode layer.

### CROSS-REFERENCE TO RELATED APPLICATIONS

This divisional application claims priority under 35 U.S.C. § 119(e) to U.S. National Stage application Ser. No. 16/464,766, filed on May 29, 2019, entitled “DIGITAL MICROFLUIDIC SYSTEMS FOR MANIPULATING DROPLETS”, which is a 371 U.S. National Stage Application of International Application No. PCT/US2017/064804, filed on Dec. 6, 2017, entitled “DIGITAL MICROFLUIDIC SYSTEM FOR MANIPULATING DROPLETS”, which claims priority to U.S. Provisional Patent Application No. 62/431,497, filed on Dec. 8, 2016, entitled “DIGITAL MICROFLUIDIC SYSTEM FOR MANIPULATING DROPLETS BY DIELECTROWETTING”, the contents of which are incorporated herein by reference.

### BACKGROUND OF THE INVENTION

### 1. Field of the Invention

The present invention relates to digital microfluidics, and, in particular, in one aspect to a circuit and method for manipulating conductive and non-conductive fluid droplets by Di electrowetting, and in another aspect to an anti-biofouling electrode for use in digital microfluidic systems.

### 2. Description of the Related Art

A lab-on-a-chip (LOC), also often referred to as a Micro Total Analysis System (μTAS), is a device that integrates a number of laboratory functions on a single, relatively small (only millimeters to a few square centimeters) chip. LOCs allow for the handling of extremely small fluid volumes (e.g., down to less than pico-liters).

Fluid control is a fundamental aspect of LOCs. Fluid control in the context of LOCs is often referred to as microfluidics. Currently, there are two main branches of microfluidics that are employed in LOCs.

The first branch, known as continuous-flow microfluidics (and also continuous fluid regulation), is based on the manipulation of continuous liquid flow through closed microfabricated channels known as microchannels. Actuation of fluid flow is implemented either by external pressure sources, external mechanical pumps, integrated mechanical micropumps, or by combinations of capillary forces and electrokinetic mechanisms. Continuous-flow microfluidics using closed microchannels is widely exploited in microfluidics for, among other things, emulsion generating, gas exchange, plasma separation and fluid mixing. Traditionally, conventional soft lithography techniques using polydimethylsiloxane (PDMS) have been used to form the closed microchannels. Recently, new, alternative methods have been developed to fabricate such microchannels. There are, however, several disadvantages to using such closed microchannel structures. For example, the functionality is unchangeable after design and fabrication, limiting the further applications of the system. Also, post operations, like cleaning, are often difficult for small features in a closed environment. In addition, mechanical components, such as pumps, tubes (including connectors) and valves, are required for most cases, increasing the complexity of such systems.

The second technique is known as digital microfluidics. In digital microfluidics, digital circuitry is used to manipulate discrete fluid droplets on a substrate, most commonly using electrowetting.

For industry, it is highly desirable for microfluidic devices to be able to be controlled automatically using a personal computer or other platform. Digital microfluidic devices, which enable individual droplet manipulations, provide an ideal platform for such automatic control.

One known digital microfluidic circuit is based on a technology known as electrowetting-on-dielectric (EWOD). In an EWOD digital microfluidic circuit, aqueous droplets are generally sandwiched and operated between two plates. One plate has an array of electrodes (typically, square or rectangular solid shape) and the other plate has a solid ground electrode covering the entire area of the plate. A thin dielectric and hydrophobic layer covers the array of electrodes and a hydrophobic layer covers the ground electrode. When an electric potential is applied to the electrodes, free charges screen the solid-liquid interface, and an electrohydro-force near the tree-phase contact line in the droplet is generated, which changes the contact angle and actuates the droplet. Water droplet creating, cutting, transporting and merging may be achieved using an EWOD device. EWOD, however, generally and reliably works with conductive fluids.

Parallel-plate-channel digital microfluidic designs have also been developed to control dielectric droplets that are positioned between two parallel plates. Such designs rely on forces exerted on the droplet originating from a phenomenon known as liquid dielectrophoresis (L-DEP). In particular, due to the existence of the dielectric liquid between the parallel plates, a non-uniform electric field is induced when power is applied to the plates. As a result, a dipole in the droplet is subjected to an unbalanced force towards the direction where the field intensity gradient is stronger, which in turn attracts the droplet and causes it to move. The L-DEP force is a body force, differing from that in EWOD.

In addition to the parallel-plate channel designs just described, additional efforts have been made to investigate the nature of L-DEP, as well as the distinction between it and electrowetting. One application utilizes the L-DEP effect on dielectric droplets on a single plate that includes interdigitated electrodes. The interdigitated electrodes generate a non-uniform electric field that penetrates into the liquid, making it possible to change the contact angle of the liquid. This technique has been called dielectrowetting. However, this actuation has only been applied to spread a single sessile droplet.

Furthermore, so called biofouling is a problem commonly encountered by many current digital (droplet-based) microfluidic systems. Bifouling occurs when biomolecules (e.g., proteins) are adsorbed to the normally hydrophobic film surfaces that are used to transport the droplets in digital microfluidic systems. This biomolecule adsorption is undesirable as it changes the properties of the surface to a hydrophilic state, thereby paralyzing reversible droplet operations. Also, cross-contaminations between different proteins can occur under such conditions.

### SUMMARY OF THE INVENTION

In one embodiment, a digital microfluidic system is provided that includes a substrate, a plurality of electrode sets provided on the substrate, wherein each of the electrode sets includes two co-planar interdigitated finger electrodes, and a driving circuit including a voltage source and a controller. Each of the electrode sets is individually addressable by the driving circuit under control of the controller such that a voltage generated by the voltage source may be selectively provided to one or more of the electrode sets.

In another embodiment, a method of driving a number of fluid droplets in a digital microfluidic system that includes a plurality of electrode sets provided on a substrate is provided, wherein each of the electrode sets includes two co-planar interdigitated finger electrodes. The method includes individually addressing one or more of the electrode sets, and selectively providing a voltage to the individually addressed one or more of the electrode sets.

In still another embodiment, an anti-biofouling electrode for a digital microfluidic system is provided that includes an electrode layer, and a slippery liquid infused porous surface structure provided on the electrode layer.

### BRIEF DESCRIPTION OF THE DRAWINGS

FIG. 1 is a schematic diagram of a digital microfluidic system according to an exemplary embodiment of the disclosed concept;

FIG. 2 is a schematic diagram of dielectrowetting chip according to an exemplary embodiment of the disclosed concept;

FIG. 3 is a schematic diagram that illustrates a creating operation in the digital microfluidic system of FIG. 1 according to the exemplary embodiment;

FIG. 4 is a schematic diagram that illustrates the splitting and transporting operations in the digital microfluidic system of FIG. 1 according to the exemplary embodiment;

FIG. 5 is a schematic diagram that illustrates the splitting and merging operations in the digital microfluidic system of FIG. 1 according to the exemplary embodiment;

FIG. 6 is a schematic diagram of an anti-biofouling coplanar electrode array according to a further aspect of the disclosed concept;

FIG. 7 is a cross-sectional view of an anti-biofouling electrode taken along lines A-A in FIG. 6 according to one particular, non-limiting exemplary embodiment;

FIG. 8 is a cross-sectional view of an anti-biofouling electrode according to an alternative exemplary embodiment (implemented in a closed environment); and

FIG. 9 is schematic view of an anti-biofouling electrode according to a further alternative exemplary embodiment.

### DETAILED DESCRIPTION OF THE INVENTION

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

As used herein, the term “controller” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

As used herein, the term “slippery liquid infused porous surface structure” shall mean a thin film structure having (i) a porous layer made of a material that includes a plurality of nanopores therein (which porous layer may be periodically ordered or random), and (ii) a lubricant liquid that is infused into the nanopores of the porous layer and/or held on the surface of the porous layer by capillarity. Non-limiting exemplary slippery liquid infused porous surface structures are described in U.S. Pat. Nos. 9,121,306, 9,121,307, and 9,353,646, each entitled “Slippery Surfaces With High Pressure Stability, Optical Transparency, and Self-Healing Characteristics”, the disclosures of which are incorporated herein by reference.

As used herein, the term “nanopore” shall mean a void having a maximum size parameter (e.g., characteristic diameter) that is less than 1000 nm.

As used herein, the term “lubricant liquid” shall mean a friction reducing liquid that is immiscible to aqueous and hydrocarbon liquids. For example, and without limitation, in one embodiment, the lubricant liquid as described herein may be a perfluorinated liquid. In another embodiment, the lubricant liquid as described herein may also be a non-volatile, chemically inert liquid, and may have a surface tension of 25 mN m⁻¹ or less, 20 mN m⁻¹ or less, or 18 mN m⁻¹ or less.

As used herein, the term “provided on” shall mean that a layer is provided directly on top of another layer or indirectly on top of another layer with one or more intervening layers in between.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the present invention can be practiced without these specific details without departing from the spirit and scope of this innovation.

Four droplet operations, specifically creating, transporting, splitting and merging, are fundamental to digital microfluidics. These droplet operations correspond to the dispensing, pumping, volume controlling and mixing operations in counterpart continuous-flow microfluidics devices. While these droplet operations have been well demonstrated in digital microfluidics devices, all such devices were based on electrowetting (or electrowetting on dielectric, EWOD), which is generally effective with conductive fluids that are commonly squeezed between two plates.

Furthermore, it has been shown that dielectrowetting, which, as noted elsewhere herein, results from L-DEP, produces superspreading (significant change in contact angle) of fluid droplets and works for both conductive and non-conductive fluids. This dielectrowetting principle has not, however, been developed for the above fundamental droplet operations. As described in detail herein, the disclosed concept applies dielectrowetting to the four fundamental microfluidic droplet operations of creating, transporting, splitting and merging, to provide a system wherein both conductive and nonconductive fluid droplets on a single plate as well as between two plates can be automatically controlled.

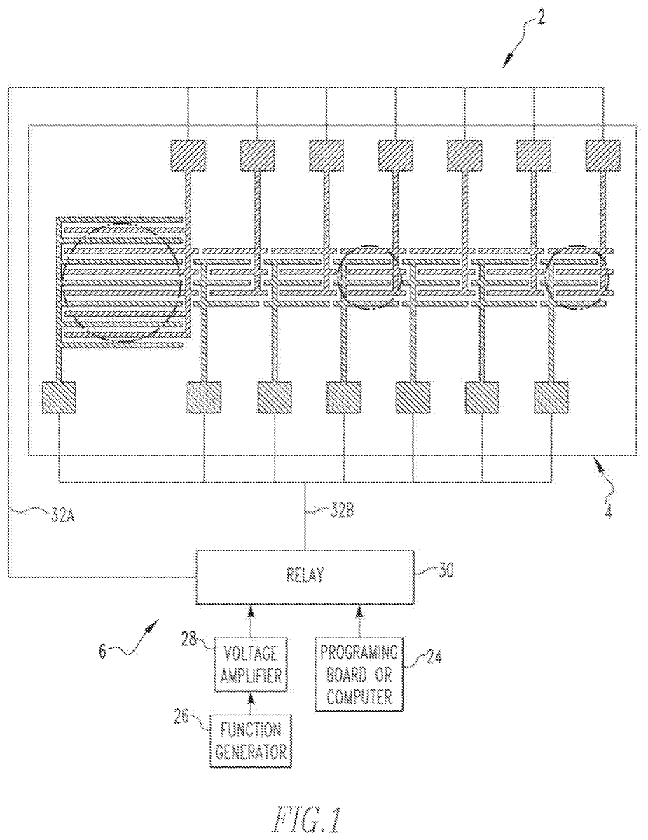

FIG. 1 is a schematic diagram of a digital microfluidic system 2 according to an exemplary embodiment of the disclosed concept. As seen in FIG. 1, digital microfluidic system 2 includes a dielectrowetting chip 4 and a driving circuit 6 coupled to dielectrowetting chip 4.

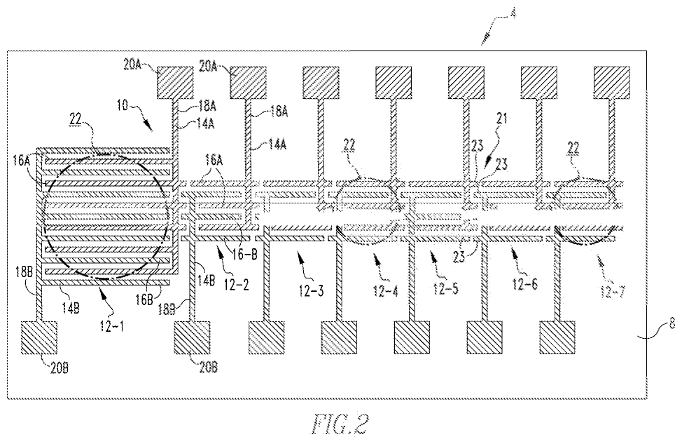

FIG. 2 is a schematic diagram of dielectrowetting chip 4 according to the illustrated embodiment. Dielectrowetting chip 4 includes a substrate 8, which in the exemplary embodiment is a glass wafer. An array 10 of a plurality of electrode sets 12 is provided on the top surface of substrate 8. In the illustrated exemplary embodiment, seven electrode sets 12 are provided, and are labeled 12-1 through 12-7 in FIG. 2 for identification. Each electrode set 12 includes two co-planar interdigitated finger electrodes 14A and 14B (made of a conductive material such as a metal like Cr, Ag, or a combination thereof). As seen in FIG. 2, each finger electrode 14A and 14B includes a plurality of finger members 16A, 16B, respectively. In each electrode set 12, finger members 16A and 16B are interdigitated with one another. In addition, in each electrode set 12, finger members 16A are coupled to a common feedline 18A having a contact member 20A, and finger members 16B are coupled to a common feedline 18B having a contact member 20B. Exemplary fluid droplets 22 are shown resting on electrode sets 12-1, 12-4, and 12-7. Thus, as described, exemplary dielectrowetting chip 4 is an open environment on a single plate.

In the illustrated embodiment, electrode sets 12 are of two different sizes. In particular, electrode set 12-1 is a “reservoir” for “dispensing” electrode set, and is larger than the remaining electrode sets 12-2 through 12-7, which are used for operating on individual fluid droplets created from the dispensing electrode set 12-1. In the example shown, electrode set 12-1 is 5.5 mm×5.5 mm (30.25 mm²) and electrode sets 12-2 through 12-7 are each 2 mm×2 mm (4 mm²). Also, both the width and spacing of electrode fingers is 50 μm. In addition, as seen in FIGS. 1 and 2, an interlocking pattern 21 of electrode members 23 is optionally provided between each adjacent pair of electrode sets 12. This interlocking pattern 21 facilitates smooth droplet movement from one electrode set 12 to another electrode set 12.

Referring again to FIG. 1, driving circuit 6 includes a controller 24, which in the exemplary embodiment is a programming board or computer. Controller 24 is structured and configured with a number of suitable software or firmware routines for controlling operation of digital microfluidic system 2 as described herein. Driving circuit 6 also includes a function generator 26 structured to generate a two terminal or two polarity AC/DC voltage that is provided to a voltage amplifier 28 for amplifying the AC/DC voltage. Driving circuit 6 also includes a relay 30 comprising a plurality of switches that is coupled to voltage amplifier 28 and controller 24. Relay 30 thus receives the amplified AC/DC voltage from voltage amplifier 28 and a number of control signals from controller 24. Finally, driving circuit 6 includes a first signal bus 32A and a second signal bus 32B, each of which is coupled to relay 30. First signal bus 32A is coupled to receive a first polarity of the amplified AC/DC voltage and second signal bus 32B is coupled to receive a second polarity of the amplified AC/DC voltage. Furthermore, as seen in FIG. 1, first signal bus 32A includes a plurality of signal lines that are individually connected to the contact members 20A of each of finger electrodes 14A. Similarly, second signal bus 32B includes a plurality of signal lines that are individually connected to the contact members 20B of each of finger electrodes 14B. In operation, controller 24 is able to selectively control the switches of relay 30 by way of one or more control signals in order to select which one or ones of electrode sets 12 is/are to receive the amplified AC/DC voltage from relay 30 at any particular time. As such, in the configuration shown in FIG. 1, the electrode sets 12 are individually addressable by controller 24.

As noted above, digital microfluidic system 2 is structured and configured to be able to perform each of the four basic droplet operations that are fundamental to digital microfluidics, namely creating, transporting, splitting and merging. In particular, controller 24 is provided with a number of software and/or firmware routines that enable digital microfluidic system 2 to perform each of the 4 basic droplet operations as described herein. An exemplary implementation of each of those operations is described below.

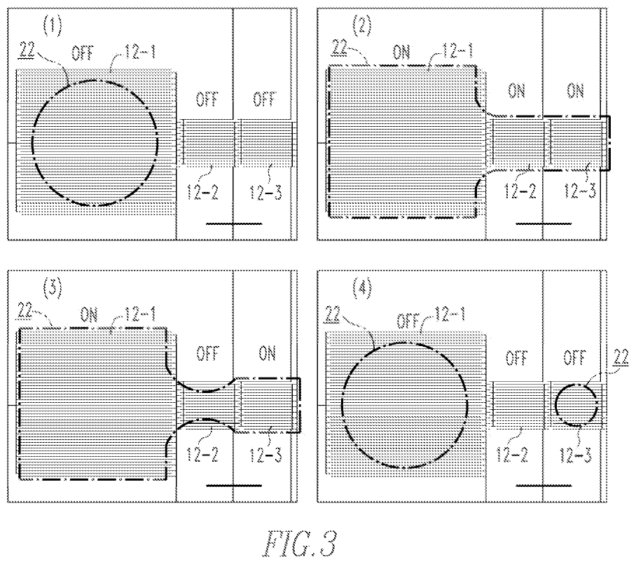

FIG. 3 illustrates the creating operation according to the exemplary embodiment. As seen in FIG. 3(1), prior to the creation of a large droplet 22 is placed in reservoir electrode set 12-1. In addition, electrode sets 12-1, 12-2 and 12-3 are each in an off condition, meaning that no voltage is being provided thereto. In the next step of the creating operation, as seen in FIG. 3(2), electrode sets 12-1, 12-2 and 12-3 are each moved to an on condition by way of controller 24 controlling relay 30 such that an AC/DC voltage is provided thereto. This will cause spreading of droplet 22 due to dielectrowetting such that droplet 22 extends across each of electrode set 12-1, 12-2 and 12-3 as seen in FIG. 3(2) (see dotted lines). Next, as seen in FIG. 3(3), controller 24 causes electrode set 12-2 to move to an off condition, which results in a portion of droplet 22 being separated from the larger portion of the droplet in reservoir electrode set 12-1. Then, as seen in FIG. 3(4), controller 24 causes electrode sets 12-1, 12-2 and 12-3 to each be moved to an off condition, with the result being that a separate, smaller droplet 22 will be present on electrode set 12-3, with a larger, although somewhat reduced in volume, droplet 22 remaining in reservoir electrode set 12-1 for future creating operations.

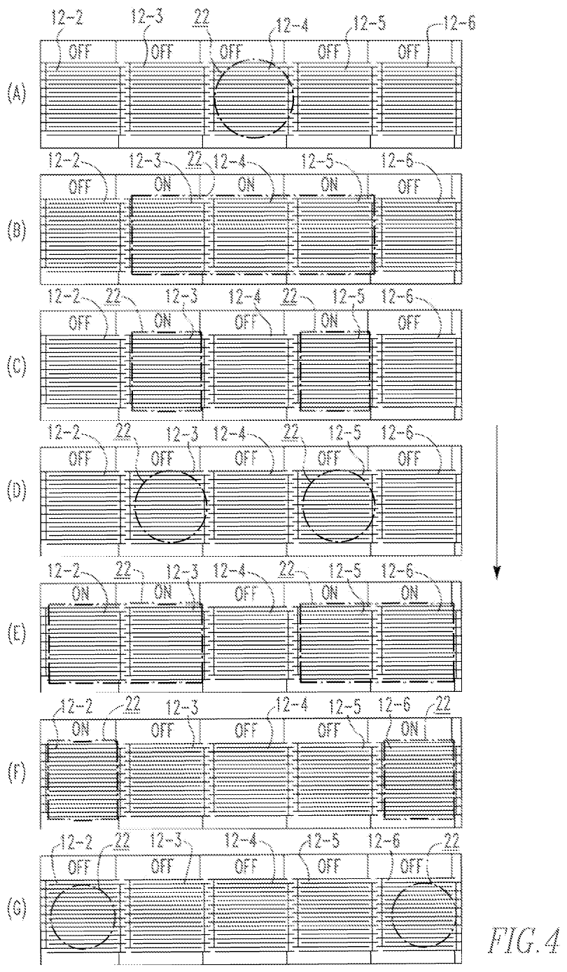

FIG. 4 illustrates the splitting and transporting operations according to the exemplary embodiment using a droplet 22 initially present on electrode set 12-4 as seen in FIG. 4(a). In addition, in this initial state, electrode sets 12-2 through 12-6 are all in an off condition. First, as shown in FIG. 4(b), the splitting operation begins when electrode sets 12-3, 12-4, and 12-5 are moved to an on condition, which causes droplet 22 to spread over those electrode sets. Then, as shown in FIG. 4(c), electrode set 12-4 is moved to an off condition, which causes the droplet 22 to split into two smaller droplets (each being in a spread condition). As seen in FIG. 4(d), electrode sets 12-3 and 12-5 are then moved to an off condition, which terminates the spreading of both of the smaller droplets 22. At this point, the original droplet 22 has now been split into two, smaller droplets 22. FIGS. 4(e)-(g) show the two droplets 22 being transported to the left and right, respectively. In particular, as shown in FIG. 4(e), electrode sets 12-2, 12-3, 12-5, and 12-6 are moved to an on condition, which causes spreading of the two droplets 22 over those electrode sets, respectively. Then, as shown in FIG. 4(f), electrode sets 12-3 and 12-5 are moved back to an off condition, which results in droplets 22 being present only on electrode sets 12-2 and 12-6 in a spread condition. Then, as shown in FIG. 4(g), electrode sets 12-2 and 12-6 are moved to an off condition, which terminates the spreading of those droplets 22, which have each been transported one electrode set in opposite directions.

FIG. 5 illustrates the splitting and merging operations according to the exemplary embodiment using a droplet 22 initially present on electrode set 12-4 as seen in FIG. 5(a). In addition, in this initial state, electrode sets 12-2 through 12-6 are all in an off condition. First, as shown in FIG. 5(b), the splitting operation begins when electrode sets 12-2 through 12-6 are all moved to an on condition, which causes droplet 22 to spread over all of those electrode sets. Then, as shown in FIG. 5(c), electrode sets 12-3 and 12-5 are each moved to an off condition, which causes the droplet 22 to split in multiple (e.g., three) smaller droplets (each being in a spread condition). As seen in FIG. 5(d), electrode sets 12-2 through 12-6 are then all moved to an off condition, which terminates the spreading of the three individual droplets 22. At this point, the original droplet 22 has now been split into three, smaller droplets 22. FIGS. 5(e)-(f) show the three droplets 22 being merged back into one larger droplet 22. First, as shown in FIG. 5(e), all of electrode sets 12-2 through 12-6 are moved to an on condition, which causes the three individual droplets 22 to be spread across all of electrode sets 12-2 through 12-6, thereby joining together. Then, as shown in FIG. 5(f), electrode sets 12-2, 12-3, 12-5, and 12-6 are moved to an off condition, which causes droplet 22 to collapse into a single droplet present on only electrode set 12-4. The original three droplets 22 have thus been merged into a single, larger droplet 22.

As described elsewhere herein, the exemplary dielectrowetting chip 4 configuration is an open environment on a single plate. It will be understood, however, that this is meant to be exemplary only, and that the disclosed concept as described herein may also be used to make a closed environment configuration including a top plate (not shown) positioned opposite the configuration shown in FIGS. 1-5 (i.e., a two-plate configuration).

Moreover, as noted elsewhere herein, biofouling is a problem commonly encountered by many current digital (droplet-based) microfluidic systems. Thus, according to a further aspect of the disclosed concept, an anti-biofouling mechanism for droplet manipulation in digital microfluidic systems is provided. Specifically, and as described in detail below, the disclosed concept includes a simple and versatile anti-biofouling droplet manipulation mechanism that may be provided on a single substrate using a slippery liquid infused porous surface structure integrated with a coplanar electrode array. This platform has been confirmed effective for both electrowetting-on-dielectric (EWOD) driving of conductive liquids (e.g., water and BSA protein solutions) and dielectrophoretic (DEP) driving of dielectric liquids (e.g., propylene carbonate and isopropyl alcohol or IPA) in an open environment. The slippery liquid infused porous surface structure described herein has been found to significantly reduce the biological adhesion because of the highly deformable nature of liquid. Biomolecules (e.g., proteins) can move easily on the slippery liquid infused porous surface structure. As a result, this property can help to overcome the burdensome biofouling problem that exists in digital microfluidics.

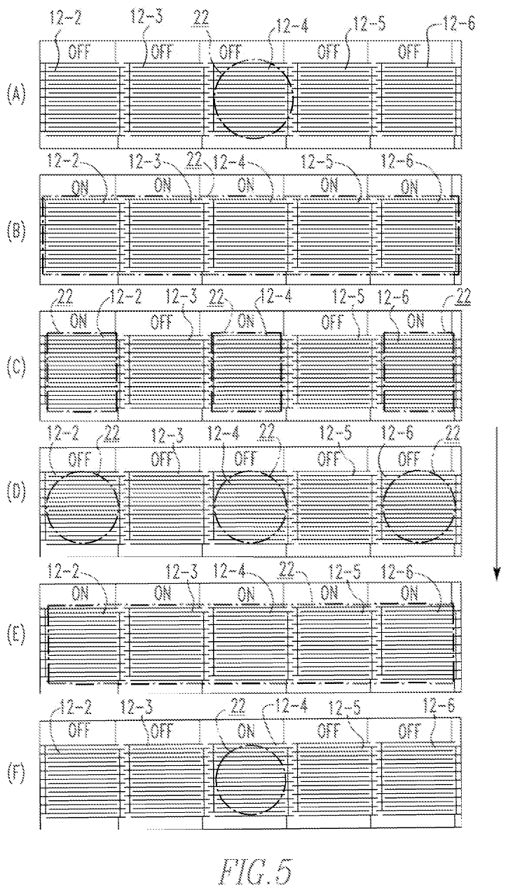

FIG. 6 is a schematic diagram of an anti-biofouling coplanar electrode array 40 to drive droplets via EWOD or L-DEP according to this aspect of the disclosed concept that may be provided on a substrate 8 as described herein. Coplanar electrode array 40 may be used in place of the array of electrode sets 12 described elsewhere herein (e.g., FIGS. 1 and 2) to form an alternative, anti-biofouling digital microfluidic system 2 according to an alternative embodiment of the disclosed concept. As seen in FIG. 6, coplanar electrode array 40 includes a plurality of adjacently arranged anti-biofouling electrode sets 41, each comprising adjacent anti-biofouling electrodes 42, labelled 42A, 42B (with the conductive electrode layers 44 thereof as described below being spaced from one another along the longitudinal (i.e., horizontal) axis of FIG. 6). As described in detail below, each anti-biofouling electrode 42A, 42B includes a slippery liquid infused porous surface structure as a part thereof.

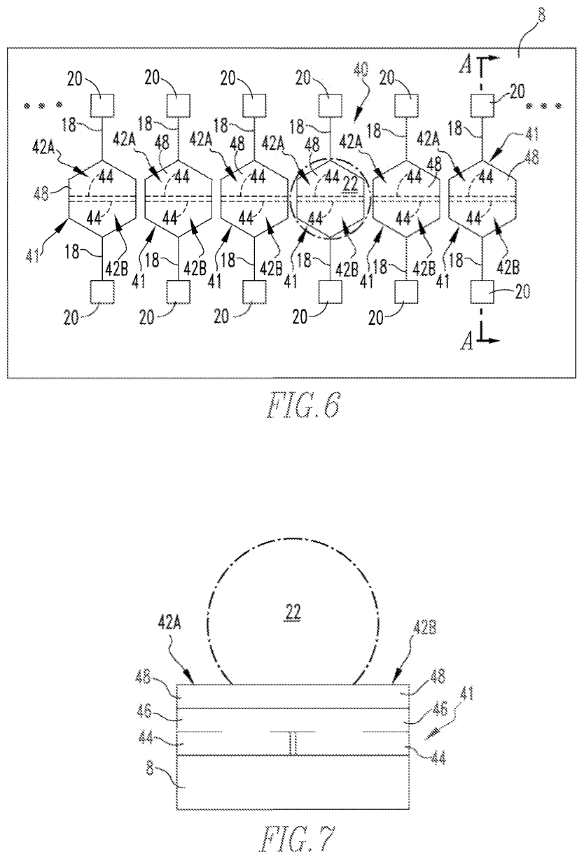

FIG. 7 is a cross-sectional view of an anti-biofouling electrode set 41 taken along lines A-A in FIG. 6 according to one particular, non-limiting exemplary embodiment. As seen in FIG. 7, each anti-biofouling electrode 42A, 42B of anti-biofouling electrode set 41 is formed on substrate 8 and comprises a multi-layer structure as described below. Specifically, each anti-biofouling electrode 42A, 42B includes a thin film conductive electrode layer 44 (with conductive electrode layers 44 in a given electrode set 41 being spaced from another as shown in FIGS. 6 and 7) that is provided directly on the surface of substrate 8 by a process such as, without limitation, E-beam evaporation and lift off patterning. Conductive electrode layer 44 may be made of, for example and without limitation, a metal such as Cr or Ag. In one particular exemplary embodiment, conductive electrode layer 44 is a 10 nm thick layer of Cr. In another particular exemplary embodiment, conductive electrode layer 44 is a 100 nm thick layer of Ag. Next, an epoxy resin layer 46 (e.g., a 2 μm thick spin coated SU-8 material) is provided directly on top of conductive electrode layer 44. Epoxy resin layer 46 may also further include a thin layer of dip coated Teflon on the top side thereof. Finally, a slippery liquid infused porous surface structure 48 is provided directly on top of epoxy resin layer 46. In the exemplary embodiment shown in FIG. 7, the epoxy resin layers 46 and the slippery liquid infused porous surface structures 48 in a given electrode set 41 are provided without any spacing therebetween (i.e., without the spacing that is provided between the conductive electrode layer 44 in the given electrode set). In other words, in a given electrode set 41, the epoxy resin layers 46 and the slippery liquid infused porous surface structures 48 are joined with one another so as to form a continuous layer across the given electrode set above the spaced conductive electrode layers 44. In addition, in the exemplary embodiment, the porous layer of slippery liquid infused porous surface structure 48 is a porous expanded polytetrafluoroethylene (ePTFE) thin film having a thickness of 8 μm and a pore size of 200-500 nm, and the lubricant liquid of slippery liquid infused porous surface structure 48 is an oil (e.g., a perfluoropolyether (PFPE) based oil such as Krytox® 103 oil). During manufacturing, Isopropyl alcohol may first be applied to the porous layer before application and subsequent infusion by capillarity of the lubricant liquid to make the film attachment more uniform.

In the configuration just described, during use in a digital microfluidic system, slippery liquid infused porous surface structure 48 will separate biomolecules (e.g., proteins) from solid surfaces and eventually prevent biofouling due to the high mobility of liquid droplets 22. Anti-biofouling electrode 42 thus provides a significant improvement for digital microfluidics systems, and, as noted herein, may be used to drive both conductive liquids and dielectric liquids in such digital microfluidics systems.

In the exemplary embodiments just described in connection with FIGS. 6 and 7, each electrode set 41 together has a hexagonal shape. It will be appreciated, however, that this is meant to be exemplary only, and that other shapes, such as, without limitation, circular, rectangular, square, or triangular shapes, may also be used within the scope of the disclosed concept. In addition, the exemplary configuration shown in FIGS. 6 and 7 is an open configuration wherein a top plate is not provided above or over coplanar electrode array 40. Again, it will be understood that this is meant to be exemplary only, and that coplanar electrode array 40 and anti-biofouling electrodes 42 as described herein may also be used in a closed environment wherein a top plate is provided above or over coplanar electrode array 40 to make a closed configuration. This is shown in, for example, FIG. 8, wherein a top plate member 50 that includes a slippery liquid infused porous surface structure 52 as at least a part thereof is provided above or over coplanar electrode array 40 to make a closed configuration. In such a configuration, top plate member 50 may or may not directly contact liquid droplets 22 (in the illustrated example, the top plate member does directly contact liquid droplets 22). In such a configuration, the entirety of the closed configuration will have anti-biofouling properties.

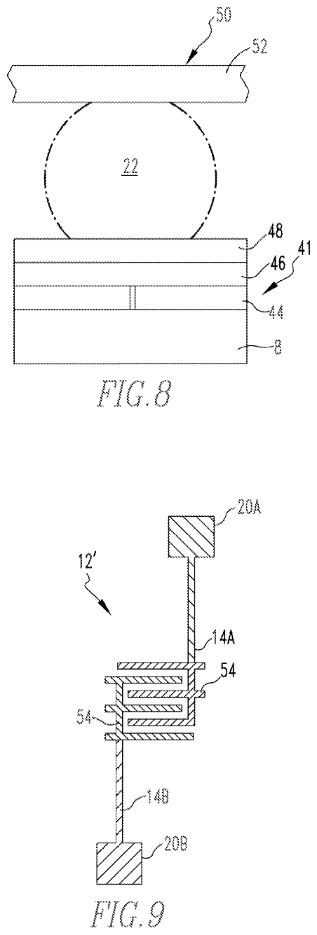

Moreover, in connection with a further alternative exemplary embodiment, the anti-biofouling aspects of the disclosed concept may be used in connection with the co-planar interdigitated finger electrodes 14A and 14B shown in FIGS. 1-5 such that those finger electrodes 14A and 14B provided with anti-biofouling properties by providing a slippery liquid infused porous surface structure on each finger electrode 14A and 14B. This is shown schematically in FIG. 9, wherein an exemplary alternative electrode set 12′ is shown with a slippery liquid infused porous surface structure 54 provided on each interdigitated finger electrode 14A and 14B.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. An electrode apparatus for a digital microfluidic system, comprising:
a conductive electrode layer; and
a slippery liquid infused porous surface structure provided on the conductive electrode layer.

2. The electrode apparatus according to claim 1, wherein the slippery liquid infused porous surface structure includes a porous layer made of expanded polytetrafluoroethylene.

3. The electrode apparatus according to claim 1, wherein the slippery liquid infused porous surface structure includes a porous layer having a pore size of 200-500 nm.

4. The electrode apparatus according to claim 1, wherein the slippery liquid infused porous surface structure includes a lubricant liquid that comprises an oil.

5. The electrode apparatus according to claim 4, wherein the oil is a perfluoropolyether (PFPE) based oil.

6. The electrode apparatus according to claim 1, wherein the conductive electrode layer comprises an electrode set comprising a first conductive electrode member and a second conductive electrode member, wherein the first conductive electrode member and the second conductive electrode member are spaced from one another along a longitudinal axis of the electrode apparatus.

7. The electrode apparatus according to claim 6, further comprising a resin layer provided between the conductive electrode layer and the slippery liquid infused porous surface structure.

8. The electrode apparatus according to claim 7, wherein the resin layer is provided directly on top of the conductive electrode layer.

9. The electrode apparatus according to claim 7, wherein the resin layer is an epoxy resin layer.

10. The electrode apparatus according to claim 7, further comprising a Teflon layer provided on a top surface of the resin layer.

11. The electrode apparatus according to claim 7, further comprising a substrate, wherein the conductive electrode layer is disposed between the substrate and the slippery liquid infused porous surface structure.

12. The electrode apparatus according to claim 6, wherein the first conductive electrode member and the second conductive electrode member are each a thin film electrode disposed directly on the substrate.

13. The electrode apparatus according to claim 8, wherein the first conductive electrode member and the second conductive electrode member are each made of Cr or Ag.

14. The electrode apparatus according to claim 6, wherein the slippery liquid infused porous surface structure covers the first conductive electrode member and the second conductive electrode member in a continuous manner to form a continuous layer.

15. The electrode apparatus according to claim 1, wherein the slippery liquid infused porous surface structure includes an expanded polytetrafluoroethylene (ePTFE) thin film having a thickness of 8 μm and a pore size of 200-500 nm, and a lubricant liquid of the slippery liquid infused porous surface structure is an oil.

16. The electrode apparatus according to claim 1, wherein the electrode apparatus is an open configuration wherein a top plate is not provided above or over the conductive electrode layer.

17. The electrode apparatus according to claim 1, wherein the electrode apparatus is a closed configuration wherein a top plate is provided above or over the conductive electrode layer.

18. A digital microfluidic system, comprising:
a substrate; and
an array of electrodes provided on the substrate, wherein each of the electrodes comprises an electrode apparatus according to claim 1.

19. The digital microfluidic system according to claim 18, wherein each electrode is part of an interdigitated finger electrode structure.

20. The digital microfluidic system according to claim 18, wherein in each electrode in the array, the slippery liquid infused porous surface structure includes an expanded polytetrafluoroethylene (ePTFE) thin film, and wherein a lubricant liquid of the slippery liquid infused porous surface structure is an oil.
